(19) United States
(12) Patent Application Publication
(10) Pub. No.: US 2026/0145325 A1
(43) Pub. Date: May 28, 2026

(54) METHOD AND APPARATUS WITH MICRO-ACTION DETERMINATION

(71) Applicant: Samsung Electronics Co., Ltd, Suwon-si (KR)

(72) Inventors: Inseop CHUNG, Suwon-si (KR); Sung Hyun CHUNG, Suwon-si (KR); Junho CHO, Suwon-si (KR); Kapje SUNG, Suwon-si (KR); Jinhyuk CHOI, Suwon-si (KR)

(73) Assignee: Samsung Electronics Co., Ltd, Suwon-si (KR)

(21) Appl. No.: 19/208,393

(22) Filed: May 14, 2025

(30) Foreign Application Priority Data
Nov. 26, 2024 (KR) 10-2024-0171156

(51) Int. Cl. B25J 9/16

(52) U.S. Cl. CPC B25J 9/1661; B25J 9/161; B25J 9/163; B25J 9/1697

(57) ABSTRACT

An electronic device includes one or more processors respectively including processing circuitry and a memory including one or more storage media configured storing code, when executed by the one or more processors, may cause the electronic device to obtain a master prompt representing a task of a robot, obtain a frame image for the robot, generate a step prompt representing a sub-task for accomplishing the task in the frame image, based on a result of applying a prompt generation model to the master prompt and the frame image, and determine a micro-action of the robot corresponding to the frame image, based on a result of applying an action generation model to the master prompt, the step prompt, and the frame image.

### CROSS-REFERENCE TO RELATED APPLICATIONS

This application claims the benefit under 35 USC § 119(a) of Korean Patent Application No. 10-2024-0171156, filed on Nov. 26, 2024, in the Korean Intellectual Property Office, the entire disclosure of which is incorporated herein by reference for all purposes.

### BACKGROUND

### 1. Field

The following description relates to a method and apparatus with micro-action determination.

### 2. Description of Related Art

Robot control technology typically relies on executing tasks along pre-programmed paths or performing predetermined actions based on specific sensor inputs. Such methods may have difficulty to flexibly respond to environment changes and have limitations in interpreting visual and linguistic information for appropriate task execution. Accordingly, there is a need for Vision Language Action (VLA) technology that can comprehend human natural language instructions and visual data to autonomously perform tasks. In this context, VLA technology refers to controlling a robot to recognize its visual environment through imaging, interpret natural language instructions, and subsequently perform precise and effective actions.

The background technology described above is something that was possessed or acquired during the process of deriving the present disclosure, and cannot necessarily be said to be publicly known technology disclosed to the general public before the filing of the present disclosure.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes obtaining a master prompt representing a task of a robot; obtaining a frame image for the robot; generating a step prompt representing a sub-task for accomplishing the task in the frame image by applying a prompt generation model to the master prompt and the frame image; and determining a micro-action of the robot corresponding to the frame image by applying an action generation model to the master prompt, the step prompt, and the frame image.

The frame image may include a first frame image, the step prompt may include a first step prompt representing a first sub-task, and the micro-action may include a first micro-action, wherein the method may further include obtaining a second frame image in response to an indication that the robot performs the first micro-action; generating a second step prompt representing a second sub-task by applying the prompt generation model to the master prompt, the first step prompt, and the second frame image; and determining, based on the second step prompt, a second micro-action of the robot corresponding to the second frame image.

The generating of the second step prompt may include applying the prompt generation model to the master prompt, the first step prompt, the first micro-action, and the second frame image.

The method may further include determining whether to generate a new step prompt different from the first step prompt, based on the second frame image; and using the first step prompt as the second step prompt based on determination not to generate the new step prompt, and wherein the generating of the second step prompt may include using the prompt generation model, based on the determination to generate the new step prompt.

The determining of whether to generate the new step prompt may include evaluating either a time interval between the first frame image and the second frame image or a number of micro-actions performed during the time interval.

The determining of whether to generate the new step prompt may include applying a prompt generation determination model to the second frame image and the first step prompt to decide whether or not to generate the new step prompt.

The determining of the micro-action may include determining, as the micro-action, one or more of a position variation of at least a portion of the robot, a rotation amount of at least a portion of the robot, or a grip strength variation, of at least a portion of the robot.

The method may further include obtaining a training prompt used for training the action generation model, wherein the generating of the step prompt may include using the training prompt.

The obtaining the training prompt may include obtaining candidate training prompts used for training the action generation model; and selecting, as the training prompt, at least one candidate training prompt related to the task among the candidate training prompts.

The determining of the micro-action may include generating an input text by concatenating the master prompt with the step prompt; and applying the action generation model to the generated input text and the frame image.

In one general aspect, provided is a non-transitory computer-readable storage medium storing code that, when executed by one or more processors, cause the electronic device to perform the method described herein.

In one general aspect, an electronic device includes one or more processors respectively including processing circuitry; and a memory including one or more storage media storing instructions, wherein the instructions, when individually or collectively executed by the one or more processors, cause the electronic device to: obtain a master prompt representing a task of a robot; obtain a frame image for the robot; generate a step prompt representing a sub-task for accomplishing the task in the frame image by applying a prompt generation model to the master prompt and the frame image; and determine a micro-action of the robot corresponding to the frame image by applying an action generation model to the master prompt, the step prompt, and the frame image.

The instructions, when individually or collectively executed by the one or more processors, further cause to the electronic device to: obtain a second frame image in response to an indication that the robot performs the first micro-action; generate a second step prompt representing a second sub-task by applying the prompt generation model to the master prompt, the first step prompt, and the second frame image; and determine, based on the second step prompt, a second micro-action of the robot corresponding to the second frame image.

The instructions, when individually or collectively executed by the one or more processors, further cause to the electronic device to: apply the prompt generation model to the master prompt, the first step prompt, the first micro-action, and the second frame image.

The instructions, when individually or collectively executed by the one or more processors, further cause to the electronic device to: determine whether to generate a new step prompt different from the first step prompt based on the second frame image; use the first step prompt as the second step prompt based on determination not to generate the new step prompt; and generate the second step prompt using the prompt generation model, based on the determination to generate the new step prompt.

The instructions, when individually or collectively executed by the one or more processors, further cause to the electronic device to: evaluate either a time interval between the first frame image and the second frame image or a number of micro-actions performed during the time interval,

The instructions, when individually or collectively executed by the one or more processors, further cause to the electronic device to: apply a prompt generation determination model to the second frame image and the first step prompt to decide whether or not to generate the new step prompt.

The instructions, when individually or collectively executed by the one or more processors, further cause to the electronic device to: determine, as the micro-action, one or more of a position variation of at least a portion of the robot, a rotation amount of at least a portion of the robot, or a grip strength variation of at least a portion of the robot.

The instructions, when individually or collectively executed by the one or more processors, further cause to the electronic device to: obtain a training prompt used for training the action generation model, and generate the step prompt based on the training prompt.

The instructions, when individually or collectively executed by the one or more processors, further cause to the electronic device to: obtain candidate training prompts used for training the action generation model; and select, as the training prompt, at least one candidate training prompt related to the task among the candidate training prompts.

Other features and aspects will be apparent from the following detailed description, the drawings, and the claims.

### BRIEF DESCRIPTION OF THE DRAWINGS

FIG. 1 illustrates an example of obtaining a micro-action for controlling a robot by an electronic device, according to one or more embodiments.

FIG. 2 illustrates an example method of determining a micro-action of a robot by an electronic device, according to one or more embodiments.

FIG. 3 illustrates an example of determining a micro-action of a robot by an electronic device, according to one or more embodiments.

FIG. 4 illustrates an example of generating a step prompt by an electronic device, according to one or more embodiments.

FIG. 5 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto will be omitted.

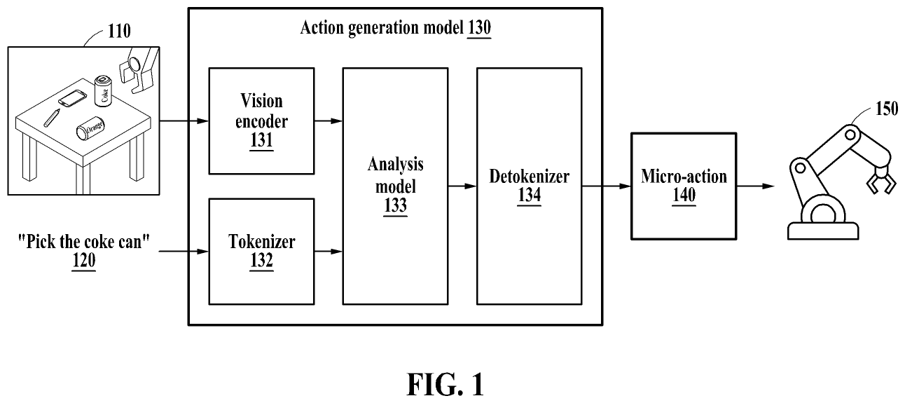

FIG. 1 illustrates an example of obtaining a micro-action for controlling a robot by an electronic device, according to one or more embodiments.

In one or more embodiments, the electronic device may obtain a micro-action 140 for a robot 150 based on a frame image 110 and a natural language instruction 120.

The frame image 110 may include an image obtained (e.g., captured) by at least a portion of the robot 150. As a non-limiting example, the frame image 110 may be acquired using a camera mounted on the robot 150. However, the frame image 110 may be obtained from a camera installed as a separate device.

At least a portion of the robot 150 shown in the frame image 110 may include an element that performs a task. In one or more embodiments, this element may also be referred to as an end effector. The end effector, which may be located at one end of the robot 150, may function as a tool for performing the task and may include one or more of a gripper, a welding tool, a spray painting tool, and/or a sensor. The frame image 110 may represent an environment or a state corresponding to a timepoint before, during, or after the task is performed.

In one or more embodiments, the natural language instruction 120 may include text that represents the task to be executed by the robot 150.

The electronic device may generate, based on a surrounding environment of at least a portion (e.g., the end effector) of the robot 150 shown in the frame image 110, a micro-action 140 that the robot 150 needs to perform in an environment shown in the frame image 110 to execute a task specified by the natural language instruction 120. The micro-action 140 may represent a unit operation and/or a very small operation performed in a situation shown in the frame image 110 among a sequence of operations performed by the robot 150 (or its end effector) to complete the task.

In one or more embodiments, the micro-action 140 may include at least one of the following: a position variation of at least a portion (e.g., the end effector) of the robot 150, a rotation amount of at least a portion (e.g., the end effector) of the robot 150, or a grip strength variation of at least a portion (e.g., the end effector) of the robot 150.

The position variation may occur along a plurality of axes. For example, the position variation may include a position variation along a first axis (e.g., an x-axis), a position variation along a second axis (e.g., a y-axis) perpendicular to the first axis, and a position variation along a third axis (e.g., a z-axis) perpendicular to the first and second axes. Here, these axes may refer to those of a three-dimensional rectangular coordinate system, which is a device coordinate system determined based on the robot 150 (or the camera mounted on the robot 150).

The rotation amount may include a rotation angle about each of the plurality of axes. For example, the rotation amount may include a rotation angle (e.g., a roll angle) about the first axis (e.g., a longitudinal axis), a rotation angle (e.g., a pitch angle) about the second axis (e.g., a lateral axis), and a rotation angle (e.g., a yaw angle) about the third axis (e.g., a vertical axis). Again, these axes may refer to those of a three-dimensional rectangular coordinate system, which is a device coordinate system determined based on the robot 150 (or the camera mounted on the robot 150).

The grip strength variation may include a change in grip strength/force when the end effector of the robot 150 functions as a gripper.

In one or more embodiments, the electronic device may obtain the micro-action 140 for the robot 150 from the frame image 110 and the natural language instruction 120 by using an action generation model 130. The action generation model 130 may include a vision encoder 131, a tokenizer 132, an analysis model 133, and a detokenizer 134.

The vision encoder 131 may perform an operation of obtaining a feature vector from the frame image 110. The tokenizer 132 may extract one or more tokens from a text (e.g., the natural language instruction 120). Although not explicitly shown in FIG. 1, the tokenizer 132 may extract one or more tokens from the feature vector of the frame image 110. A token may serve as a symbolic representation, which is used by the analysis model 133 as a unit of information. The analysis model 133 may generate information about the micro-action 140 as an output token from the token generated using the tokenizer 132. For example, the analysis model 133 may be implemented using, in whole or in part, a neural network (e.g., a convolution neural network (CNN)), a transformer, and/or a large language model (LLM). The detokenizer 134 may generate the micro-action 140 from the output token obtained based on the analysis model 133.

The electronic device may control the robot 150 based on the micro-action 140 of the robot 150. In one or more embodiments, the electronic device may be integrated with the robot 150 as a single device. The electronic device may control a driver of the robot 150 according to the micro-action 140. The electronic device may be implemented separately (e.g., as a separate electronic device) from the robot 150, and transmit a control instruction based on the micro-action 140 to the robot 150. The robot 150 may actuate/drive at least a portion of the robot 150 in response to the control instruction received from the electronic device.

The electronic device may obtain an additional frame image after the robot 150 moves at least a portion of the robot 150 based on the micro-action 140. As a result of the movement, an environment (or a state) shown in the additional frame image may differ from that shown in the original frame image 110. The electronic device may generate a subsequent micro-action 140 based on the natural language instruction 120 and the additional (new) frame image, thereby controlling at least a portion of the robot 150. By repeatedly updating the frame image (110) to reflect environmental changes and generating corresponding micro-actions (140) based on the natural language instruction (120), the electronic device may generate a series of micro-actions to complete the task.

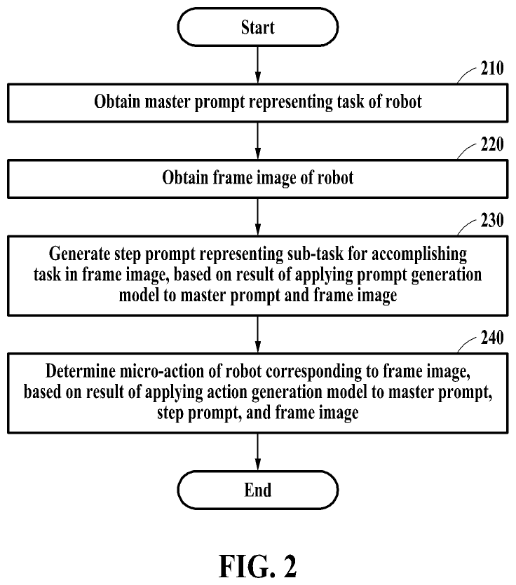

However, when the natural language instruction 120 remains unchanged across multiple frame images despite environmental changes, an issue may arise where the natural language instruction 120 does not accurately reflect updated environment. In such cases, the electronic device may modify the natural language instruction 120 in response to the environmental change, in addition to updating the frame image 110. The change of the natural language instruction 120 according to the environmental change is described in more detail with reference to FIGS. 2 to 4.

FIG. 2 illustrates an example method of determining a micro-action of a robot by an electronic device, according to one or more embodiments.

In one or more embodiments, the electronic device may determine a micro-action (e.g., the micro-action 140 of FIG. 1) for a robot (e.g., the robot 150 of FIG. 1) based on a frame image (e.g., the frame image 110 of FIG. 1) and a natural language instruction (e.g., the natural language instruction 120 of FIG. 1).

The electronic device may use both a master prompt and a step prompt as the natural language instruction. The master prompt may include a natural language text representing an overall task. The step prompt may include a natural language text representing a sub-task to be performed in an environment (or a state) shown in the frame image for the task. In one or more embodiments, the step prompt may also be referred to as a guide prompt. The sub-task may refer to a result of dividing the task. For example, when the task is to pick up a coke can, the sub-task may include approaching the coke can, aligning a robotic arm with the coke can, positioning/placing the coke can within a grip area of a gripper, and actuating the gripper to pick up the coke can.

In operation 210, the electronic device may obtain the master prompt representing the task of the robot. For example, the electronic device may obtain, from a user, the master prompt for instructing the task of the robot.

In operation 220, the electronic device may acquire the frame image of the robot. The frame image may be captured for at least a portion of the robot (e.g., an end effector), as described above with reference to FIG. 1. The frame image may include pixel values (e.g., R, G, and B values) of each of a plurality of pixels.

In operation 230, the electronic device may generate the step prompt representing the sub-task for completing the task in the depicted environment, by applying a prompt generation model to the master prompt and the frame image.

The prompt generation model may be generated and/or trained to output data corresponding to the step prompt from input data corresponding to the master prompt and the frame image. In one example, the prompt generation model may be implemented based on all or a portion of at least one of a neural network (e.g., a CNN), a transformer, an LLM, and/or a vision language model (VLM).

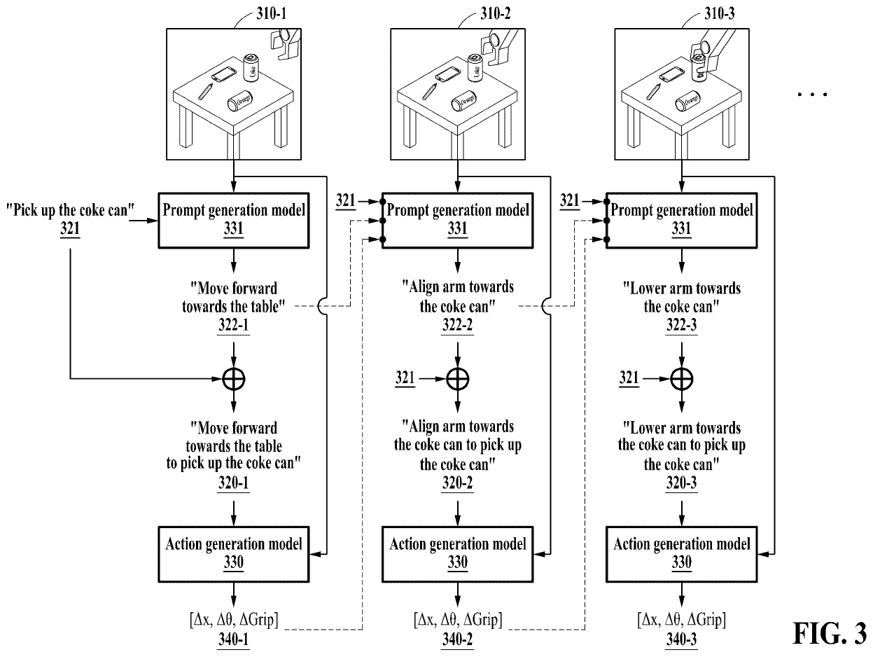

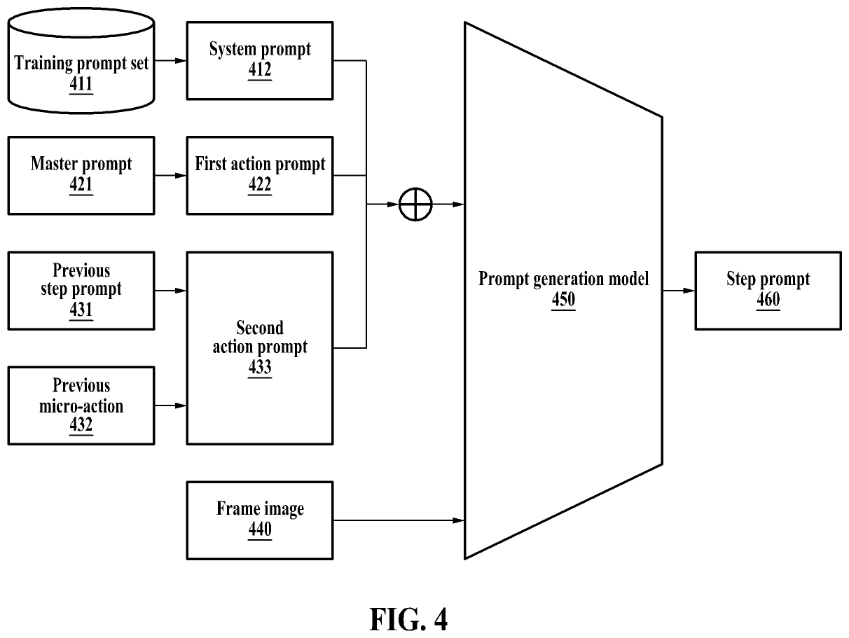

The generation of the step prompt is described in more detail below with reference to FIGS. 3 and 4.

In operation 240, the electronic device may determine the micro-action of the robot corresponding to the frame image by applying an action generation model (e.g., the action generation model 130 of FIG. 1) to the master prompt, the step prompt, and the frame image.

The action generation model may be generated and/or trained to output data corresponding to the micro-action of the robot from input data corresponding to the natural language instruction and the frame image. In one example, the action generation model may be implemented based on all or a portion of at least one of a neural network (e.g., a CNN), a transformer, an LLM, a VLM, and/or a vision language action (VLA) model.

In one or more embodiments, the action generation model may be generated and/or trained to extract a true-value micro-action from a training frame image and a training prompt. For example, the action generation model may use a training set, which may include training input (i.e., training frame image and training prompts), and corresponding training pairs of the true-value micro-action. A parameter of a temporary action generation model may be updated based on a loss determined by a difference between a temporary micro-action (e.g., training output) output from the training input and the true-value micro-action. The temporary action generation model may refer to the action generation model prior to completion of training.

In one example, the electronic device may generate input text by concatenating the master prompt with the step prompt. The input text may be used as the natural language instruction for the action generation model. The electronic device may apply the action generation model to the generated input text and the frame image to determine the micro-action of the robot based on the output data of the micro-action.

The generation of the micro-action is described in more detail below with reference to FIG. 3.

FIG. 3 illustrates an example of determining a micro-action of a robot by an electronic device, according to according to one or more embodiments.

In one or more embodiments, the electronic device may generate a step prompt and a micro-action (e.g., the micro-action 140 of FIG. 1) based on a master prompt 321 and a frame image (e.g., the frame image 110 of FIG. 1).

Referring to FIG. 3, the electronic device may obtain the master prompt 321. For example, the master prompt 321 may be “pick up the coke can”. Subsequently, the electronic device may obtain a first frame image 310-1.

The electronic device may then generate a first step prompt 322-1 representing a first sub-task, based on a result of applying a prompt generation model 331 to the master prompt 321 and the first frame image 310-1. For example, the first step prompt 322-1 may be “move forward towards the table.” The electronic device may concatenate the master prompt 321 with the first step prompt 322-1 to generate a first input text 320-1 (e.g., “move forward towards the table to pick up the coke can”). The electronic device may subsequently generate a first micro-action 340-1 based on a result of applying an action generation model 330 to the first input text 320-1 and the first frame image 310-1. A robot (e.g., the robot 150 of FIG. 1) may control (e.g., drive) at least a portion of the robot based on the first micro-action 340-1.

In response to an indication that the robot performs the first micro-action 340-1, the electronic device may obtain a second frame image 310-2. The second frame image 310-2 may include a frame image captured for the robot after the robot completes performing the first micro-action 340-1. The electronic device may generate a second micro-action 340-2 based on the master prompt 321 and the second frame image 310-2.

In one example, the electronic device may generate a new step prompt (e.g., a second step prompt 322-2) for a current frame image (e.g., the second frame image 310-2) using a previous step prompt (e.g., the first step prompt 322-1) and/or a previous micro-action (e.g., the first micro-action 340-1) corresponding to a previous frame image (e.g., the first frame image 310-1) that temporally precedes the current frame image.

Referring to FIG. 3, the electronic device may generate the second step prompt 322-2 representing a second sub-task by applying the prompt generation model 331 to the master prompt 321, the first step prompt 322-1, the first micro-action 340-1, and the second frame image 310-2. For example, the second step prompt 322-2 may be “align arm towards the coke can.” The electronic device may concatenate the master prompt 321 with the second step prompt 322-2 to generate a second input text 320-2 (e.g., “align arm towards the coke can to pick up the coke can”), and then apply the action generation model 330 to the second input text 320-2 and the second frame image 310-2 to generate the second micro-action 340-2. The robot may control (e.g., drive) at least a portion of the robot based on the second micro-action 340-2.

In response to an indication that the robot executes the second micro-action 340-2, the electronic device may obtain a third frame image 310-3, which is captured for the robot after the second micro-action 340-2 is performed. The electronic device may generate a third micro-action 340-3 based on the master prompt 321 and the third frame image 310-3 in a manner similar to that used for generating the first micro-action 340-1 and the second micro-action 340-2.

Referring to FIG. 3, the electronic device may generate a third step prompt 322-3 representing a third sub-task by applying the prompt generation model 331 to the master prompt 321, the second step prompt 322-2, the second micro-action 340-2, and the third frame image 310-3. For example, the third step prompt 322-3 may be “lower arm towards the coke can.” The electronic device may concatenate the master prompt 321 with the third step prompt 322-3 to generate a third input text 320-3 (e.g., “lower arm towards the coke can to pick up the coke can”), and then apply the action generation model 330 to the third input text 320-3 and the third frame image 310-3 to generate the third micro-action 340-3. The robot may control (e.g., drive) at least a portion of the robot based on the third micro-action 340-3.

In one or more embodiments illustrated in FIG. 3, the electronic device may generate a new step prompt each time the electronic device obtains a frame image; however, it is not limited to generating the new step prompt each time the electronic device obtains a frame image. The electronic device may determine whether or not to generate a new step prompt each time a frame image is acquired.

For example, the electronic device may obtain the second frame image 310-2 after the robot performs the first micro-action 340-1. The electronic device may determine whether to generate a new step prompt different from the first step prompt 322-1 based on the content of the second frame image 310-2. Based on the determination not to generate the new step prompt, the electronic device may reuse (e.g., use identically) the first step prompt 322-1 as the second step prompt 322-2. The electronic device may generate the second step prompt 322-2 using the prompt generation model 331, based on the determination to generate the new step prompt.

In one example, the electronic device may determine whether to generate the new step prompt, distinct from the first step prompt 322-1, based on a result of evaluating either a time interval between the first frame image 310-1 and the second frame image 310-2 or the number of micro-actions performed during that interval.

For example, the electronic device may determine to generate the new step prompt when a time interval between obtaining the first frame image 310-1 and the second frame image 310-2 exceeds a predetermined threshold time interval (e.g., 5 seconds). Conversely, the electronic device may determine not to generate the new step prompt when the time interval is less than or equal to this threshold time interval.

For example, the electronic device may determine to generate the new step prompt based on the number of micro-actions performed between the first frame image 310-1 and the second frame image 310-2 meeting or exceeding a predetermined threshold number (e.g., “20”). The electronic device may determine not to generate the new step prompt based on the number of micro-actions performed between the first frame image 310-1 and the second frame image 310-2 being below this threshold number. The electronic device may use the same step prompt for a number of frame images equal to the threshold number (e.g., “20”) and may then generate the new step prompt for a subsequent frame image.

According to an example, the electronic device may determine whether to generate a new step prompt different from the first step prompt 322-1 by applying a prompt generation determination model to the second frame image 310-2 and the first step prompt 322-1.

The prompt generation determination model may be generated and/or trained to output data indicating whether a new step prompt should be generated for a current frame image (e.g., the second frame image 310-2) based on input data corresponding to the current frame image and a previous step prompt (e.g., the first step prompt 322-1). The prompt generation determination model may be implemented, in whole or in part, using a neural network (e.g., a CNN), a transformer, an LLM, and/or a VLM.

For example, the prompt generation determination model may be implemented as a separate model from the prompt generation model 331, or may be integrated within the prompt generation model 331. When the prompt generation determination model is integrated within the prompt generation model 331, output data from the prompt generation model 331 may include the same previous step prompt when it is determined that no new step prompt should be generated. The output data of the prompt generation model 331 may include a new step prompt distinct from the previous step prompt when it is determined that a new step prompt should be generated.

FIG. 4 illustrates an example of generating a step prompt by an electronic device, according to one or more embodiments.

In one or more embodiments, an electronic device may generate a step prompt 460 (e.g., the first step prompt 322-1 of FIG. 3, the second step prompt 322-2 of FIG. 3, the third step prompt 322-3 of FIG. 3) by applying a prompt generation model 450 (e.g., the prompt generation model 331 of FIG. 3) to a system prompt 412, a first action prompt 422, a second action prompt 433, and a frame image 440. The system prompt 412 may be commonly provided to the prompt generation model 450 across a plurality of frame images (e.g., the first frame image 310-1, the second frame image 310-2, and the third frame image 310-3 of FIG. 3).

The system prompt 412 may include, at least in part, a training prompt (e.g., a natural language instruction) used for training an action generation model (e.g., the action generation model 130 of FIG. 1 or the action generation model 330 of FIG. 3). The electronic device may generate the step prompt 460 that is the same as or similar to the training prompt of the action generation model, based on a result of applying the prompt generation model 450 to the system prompt 412. Since the action generation model is trained using the training prompt, the action generation model may output more accurate micro-actions based on the step prompt 460 that is the same as or similar to the training prompt.

In one example, the electronic device may obtain the training prompt used for training the action generation model, and generate the step prompt 460 based on the training prompt.

For example, the electronic device may obtain a set of candidate training prompts used for training the action generation model. The electronic device may select, as the training prompt, at least one candidate training prompt related to a task among the candidate training prompts. For example, the selection may be based on a similarity level between each candidate training prompt and a master prompt 421 (e.g., the master prompt 321 of FIG. 3). The similarity level may be determined by comparing embedding vectors, using metrics (e.g., a cosine similarity level and/or an L2 norm), obtained from a text encoder. The text encoder may be a machine learning model generated and/or trained to output an embedding vector from a given text (e.g., the candidate training prompt and/or the master prompt 421). The text encoder may be implemented, in whole or in part, using a neural network (e.g., a recurrent neural network (RNN)), a transformer, or an LLM.

Referring to FIG. 4, the electronic device may obtain the system prompt 412 based on a training prompt set 411, which may include one or more training prompts (or the candidate training prompts) used for training the action generation model.

In one example, the system prompt 412 may include one or more of the following: text describing a role of the prompt generation model 450, text describing a goal of the prompt generation model 450, or text describing the training prompt of the action generation model. The text regarding the role of the prompt generation model 450 may describe generating the step prompt 460 representing a sub-task based on an input task (or the master prompt 421). The text regarding the goal of the prompt generation model 450 may describe suggesting a sub-task necessary for completing the input task. The text regarding the training prompt of the prompt generation model 450 may describe that the training prompt was used during training, and may request generation of a sub-task that considers the training prompt.

The electronic device may obtain the first action prompt 422 based on the master prompt 421. The first action prompt 422 may include a text that requests generation of the step prompt 460 representing the sub-task needed to complete the task specified by the master prompt 421.

In one example, the first action prompt 422 may include at least one of a text requesting a sub-task for performing a task described in the master prompt 421 in an environment depicted in an image (e.g., the frame image 440) or a text requesting output of a very small step of an action as a sub-task. The first action prompt 422 may also include a text that limits the number of words (e.g., to “5” words or less) in the step prompt 460 and/or a text that limits an output period. Such a text limiting the output period may be added to the first action prompt 422 for facilitate subsequent concatenation of the step prompt 460 with the master prompt 421, as described above with reference to FIG. 4.

The electronic device may obtain the second action prompt 433 based on a previous step prompt 431 and a previous micro-action 432. The previous step prompt 431 may refer to the step prompt 460 used to obtain the previous micro-action 432 from a previous frame image that temporally precedes the frame image 440. The previous micro-action 432 may refer to a micro-action obtained from the previous frame image.

In one example, the second action prompt 433 may include a text describing the previous step prompt 431 and the previous micro-action 432. The second action prompt 433 may further include a text indicating that the image to be input (e.g., the frame image 440) is obtained as a result of performing the previous step prompt 431 and/or a text requesting generation of the step prompt 460 that is consistent with the previous step prompt 431 (or the previous micro-action 432).

Table 1 illustrates specific examples of the system prompt 412, the first action prompt 422, and the second action prompt 433.

TABLE 1

| Prompt | Text | Example |
|---|---|---|
| System | Text describing the role of the prompt | You are a helpful assistant that pays |
| prompt | generation model | attention to the user's instructions and |
| | | guides the robot policy to complete the |
| | | given instruction. |
| | Text describing the goal of the prompt | Your goal is to propose the next action |
| | generation model | for the robot policy to complete the |
| | | given instruction. |
| | Text 1 describing the training prompt of | These are some of the language |
| | the action generation model | instructions the policy has seen during |
| | | training, {instruction set}. |
| | Text 2 describing the training prompt of | Consider these instructions when |
| | the action generation model | proposing the next action for the policy. |
| First | Text requesting the sub-task | The instruction given by the user is to |
| action | | {language instruction}, how should the |
| prompt | | robot policy move to complete the given |
| | | instruction in the environment shown in |
| | | the given input image? |
| | Text requesting the output of a very | Output a very small step of action for |
| | small step of the action as the sub-task | the robot policy to execute the given |
| | | instruction at the given state shown in |
| | | the image. |
| | Text limiting the number of words in the | The given output should be a very short |
| | step prompt | and simple sentence less than five |
| | | words. |
| | Text limiting the output of periods | Do not write period at the end of the |
| | | sentence. |
| Second | Text describing the previous step | The action you previously provided was |
| action | prompt and the previous micro-action | {previous guide prompt} and the |
| prompt | | following action executed by the robot |
| | | policy was {previous robot action}. |
| | Text describing that the input image is | Note that the input image is the |
| | the result of performing the previous | consequence of your previous action. |
| | step prompt | |
| | Text requesting generation of the step | Make sure your next action prediction |
| | prompt that is consistent with the | aligns well with the previous ones. |
| | previous step prompt (or the previous | |
| | micro-action) | |

Here, {instruction set} may refer to a training prompt, {language instruction} may refer to a master prompt, {previous guide prompt} may refer to a previous step prompt, and {previous robot action} may refer to a previous micro-action. In addition, action may refer to a sub-task and/or a step prompt, and robot policy may refer to an action generation model (or an action including one or more micro-actions obtained using the action generation model).

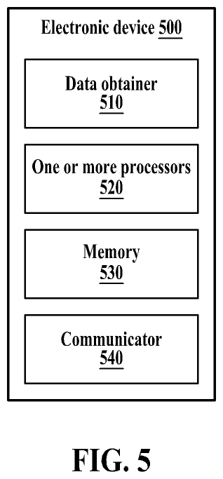

FIG. 5 illustrates an example electronic device according to one or more embodiments.

In one or more embodiments, an electronic device 500 may include a data obtainer 510, one or more processors 520, a memory 530, and a communicator 540.

The data obtainer 510 may be configured to obtain a master prompt and/or a frame image. For example, the data obtainer 510 may be implemented as, as a part of, the communicator 540 and may obtain the master prompt and/or the frame image from an external device via the communicator 540. For example, the data obtainer 510 may include a vision sensor (e.g., a camera) to generate the frame image. For example, the data obtainer 510 may include a user input device (e.g., a microphone and a keyboard) to receive the master prompt based on user input (e.g., voice and/or text).

The one or more processors 520 may obtain the master prompt and the frame image from the data obtainer 510. The one or more processors 520 may generate a step prompt using a prompt generation model, and determine a micro-action using the step prompt. When the one or more processors 520 obtains an additional frame image, the one or more processors 520 may generate a new step prompt, which is distinct from the previous one. The processor 520 may then generate an additional micro-action based on the additional (updated) frame image and the new step prompt. In one example, the one or more processors 520 may respectively include processing circuitry.

The memory 530 may temporarily and/or permanently store one or more of the master prompt, the frame image, the step prompt, the prompt generation model, the action generation model, or the micro-action. The memory 530 may store instructions (e.g., code) for obtaining the master prompt, obtaining the frame image, generating the step prompt, and/or determining the micro-action. The instructions, when executed by the one or more processor 520, may configure the one or more processors 520 of electronic device 500 to perform operations directed by the instructions. However, this is only an example and does not limit information stored in the memory 530.

The communicator 540 may transmit and receive one or more of the master prompt, the frame image, the step prompt, the prompt generation model, the action generation model, or the micro-action. The communicator 540 may establish a wired communication channel and/or a wireless communication channel with an external device (e.g., a robot, another electronic device, and a server) via a long-distance communication network, such as cellular communication, short-range wireless communication, local area network (LAN) communication, Bluetooth, wireless fidelity (WiFi) direct or infrared data association (IrDA), legacy cellular networks, fourth generation (4G) and/or fifth generation (5G) networks, next-generation communication, the Internet, or a computer network (e.g., an LAN or a wide area network (WAN)).

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The electronic devices, sensors, processors, memories, cameras, storage devices, models, communicators, and other apparatuses, devices, models, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
obtaining a master prompt representing a task of a robot;
obtaining a frame image for the robot;
generating a step prompt representing a sub-task for accomplishing the task in the frame image by applying a prompt generation model to the master prompt and the frame image; and
determining a micro-action of the robot corresponding to the frame image by applying an action generation model to the master prompt, the step prompt, and the frame image.

2. The method of claim 1, wherein
the frame image includes a first frame image,
the step prompt includes a first step prompt representing a first sub-task, and
the micro-action includes a first micro-action,
wherein the method further comprises:
obtaining a second frame image in response to an indication that the robot performs the first micro-action;
generating a second step prompt representing a second sub-task by applying the prompt generation model to the master prompt, the first step prompt, and the second frame image; and
determining, based on the second step prompt, a second micro-action of the robot corresponding to the second frame image.

3. The method of claim 2, wherein
the generating of the second step prompt comprises applying the prompt generation model to the master prompt, the first step prompt, the first micro-action, and the second frame image.

4. The method of claim 2, further comprising:
determining whether to generate a new step prompt different from the first step prompt, based on the second frame image; and
using the first step prompt as the second step prompt based on determination not to generate the new step prompt, and
wherein the generating of the second step prompt comprises using the prompt generation model, based on the determination to generate the new step prompt.

5. The method of claim 4, wherein
the determining of whether to generate the new step prompt comprises evaluating either a time interval between the first frame image and the second frame image or a number of micro-actions performed during the time interval.

6. The method of claim 4, wherein
the determining of whether to generate the new step prompt comprises applying a prompt generation determination model to the second frame image and the first step prompt to decide whether or not to generate the new step prompt.

7. The method of claim 1, wherein
the determining of the micro-action comprises determining, as the micro-action, one or more of a position variation of at least a portion of the robot, a rotation amount of at least a portion of the robot, or a grip strength variation, of at least a portion of the robot.

8. The method of claim 1, further comprising:
obtaining a training prompt used for training the action generation model,
wherein the generating of the step prompt comprises using the training prompt.

9. The method of claim 8, wherein
the obtaining the training prompt comprises obtaining candidate training prompts used for training the action generation model; and
selecting, as the training prompt, at least one candidate training prompt related to the task among the candidate training prompts.

10. The method of claim 1, wherein
the determining of the micro-action comprises:
generating an input text by concatenating the master prompt with the step prompt; and
applying the action generation model to the generated input text and the frame image.

11. A non-transitory computer-readable storage medium storing code that, when executed by one or more processors, cause the electronic device to perform the method of claim 1.

12. An electronic device comprising:
one or more processors respectively including processing circuitry; and
a memory including one or more storage media storing instructions,
wherein the instructions, when individually or collectively executed by the one or more processors, cause to the electronic device to:
obtain a master prompt representing a task of a robot;
obtain a frame image for the robot;
generate a step prompt representing a sub-task for accomplishing the task in the frame image by applying a prompt generation model to the master prompt and the frame image; and
determine a micro-action of the robot corresponding to the frame image by applying an action generation model to the master prompt, the step prompt, and the frame image.

13. The electronic device of claim 12, wherein
the frame image includes a first frame image,
the step prompt representing the sub-task includes a first step prompt representing a first sub-task, and
the micro-action includes a first micro-action,
wherein the instructions, when individually or collectively executed by the one or more processors, further cause to the electronic device to:
obtain a second frame image in response to an indication that the robot performs the first micro-action;
generate a second step prompt representing a second sub-task by applying the prompt generation model to the master prompt, the first step prompt, and the second frame image; and
determine, based on the second step prompt, a second micro-action of the robot corresponding to the second frame image.

14. The electronic device of claim 13, wherein the instructions, when individually or collectively executed by the one or more processors, further cause to the electronic device to:
apply the prompt generation model to the master prompt, the first step prompt, the first micro-action, and the second frame image.

15. The electronic device of claim 13, wherein the instructions, when individually or collectively executed by the one or more processors, further cause to the electronic device to:
determine whether to generate a new step prompt different from the first step prompt based on the second frame image;
use the first step prompt as the second step prompt based on determination not to generate the new step prompt; and
generate the second step prompt using the prompt generation model, based on the determination to generate the new step prompt.

16. The electronic device of claim 15, wherein the instructions, when individually or collectively executed by the one or more processors, further cause to the electronic device to:
evaluate either a time interval between the first frame image and the second frame image or a number of micro-actions performed during the time interval,

17. The electronic device of claim 15, wherein the instructions, when individually or collectively executed by the one or more processors, further cause to the electronic device to:
to apply a prompt generation determination model to the second frame image and the first step prompt to decide whether or not to generate the new step prompt.

18. The electronic device of claim 12, wherein the instructions, when individually or collectively executed by the one or more processors, further cause to the electronic device to:
determine, as the micro-action, one or more of a position variation of at least a portion of the robot, a rotation amount of at least a portion of the robot, or a grip strength variation of at least a portion of the robot.

19. The electronic device of claim 12, wherein the instructions, when individually or collectively executed by the one or more processors, further cause to the electronic device to:
obtain a training prompt used for training the action generation model, and
generate the step prompt based on the training prompt.

20. The electronic device of claim 19, wherein the instructions, when individually or collectively executed by the one or more processors, further cause to the electronic device to:
obtain candidate training prompts used for training the action generation model; and
select, as the training prompt, at least one candidate training prompt related to the task among the candidate training prompts.
